(19) United States
(12) Patent Application Publication
(10) Pub. No.: US 2007/0283064 A1
(43) Pub. Date: Dec. 6, 2007

(54) Arbiter and arbitrating method

(75) Inventor: Kuen-Bin Lai, Hsinchu City (TW)

Correspondence Address: BIRCH STEWART KOLASCH & BIRCH, PO BOX 747, FALLS CHURCH, VA, 22040-0747, US

(73) Assignee: REALTEK SEMICONDUCTOR CORP., Hsinchu (TW)

(21) Appl. No.: 11/723,136

(22) Filed: Mar. 16, 2007

(30) Foreign Application Priority Data
Mar. 16, 2006 (TW) 095108876

(51) Int. Cl. G06F 13/362

(52) U.S. Cl. 710/116

(57) ABSTRACT

The invention discloses an arbiter for arbitrating the mastership of a bus. The bus is coupled to a plurality of masters. The arbiter includes a request detection unit, a latency count unit, a grant generation unit, and an arbitration control unit. The request detection unit is used for detecting a plurality of request signals corresponding to the masters. According to a latency cycle of each request signal, the latency count unit counts the decayed latency of each request signal and further compares the decayed latency of each request signal, so as to determine the level of priority given to a designated master. Accordingly, the arbitration control unit is configured to control the grant generation unit to selectively generate a grant signal, such that the designated master with a higher level of priority will obtain the mastership of the bus based on the grant signal.

### BACKGROUND OF THE INVENTION

1. Field of the Invention

The present invention relates to an arbiter and an arbitrating method thereof and, more particularly, to an arbiter and an arbitrating method capable of arbitrating a mastership of a bus based on the latency cycle of each master and the priority of transaction.

2. Description of the Prior Art

Recently, computer systems have evolved toward more real time applications, including multimedia applications such as video and audio, video capture and playback, telephony, and speech recognition. Therefore, in computer systems, a bus is usually coupled to a plurality of masters, such as a central processing unit (CPU), a video adapter, an audio adapter, or other peripheral devices, so as to execute various programs, and an arbiter in charge of arbitrating the mastership of the bus.

In prior art, the arbiter of the computer system utilizes predetermined priority to determine which master will possess the bandwidth of the bus. In other words, when a master with a higher level of priority sends request signals continuously to the arbiter, the bandwidth of the bus will always be occupied by the master, interfering the execution of other real time applications that leads to problems such as asynchronous video/audio playback and discontinuous frames.

To solve the aforesaid problems, the prior art may have to increase the First-In First-Out (FIFO) memory capacity in the computer system. However, increased FIFO memory with a raise of cost does no help to the optimization of bandwidth distribution.

Therefore, the scope of the present invention is to provide an arbiter and an arbitrating method thereof to solve the aforementioned problems.

### SUMMARY OF THE INVENTION

A scope of the invention is to provide an arbiter and an arbitrating method thereof capable of arbitrating the mastership of a bus based on the latency cycle of each master and the priority of transaction.

According to a preferred embodiment of the invention, the arbiter is used for arbitrating the mastership of a bus, and the bus is coupled to a plurality of masters. In this embodiment, the arbiter comprises a request detection unit, a latency count unit, a grant generation unit, and an arbitration control unit. The latency count unit is coupled to the request detection unit, and the arbitration control unit is coupled to the latency count unit and the grant generation unit.

In this embodiment, the request detection unit is used for detecting a plurality of request signals, each of which corresponds to one of the masters. The latency count unit is used for counting the decayed latency of each request signal according to a latency cycle of each request signal. The latency count unit further compares the decayed latency of each request signal, so as to determine the level of priority given to a designated master. The arbitration control unit is configured to control the grant generation unit to selectively generate a grant signal according to the level of priority, such that the designated master with a higher level of priority obtains the mastership of the bus based on the grant signal.

Therefore, the arbiter of the invention is capable of arbitrating the mastership of the bus based on the latency cycle of each master and the priority of transaction. Accordingly, the bandwidth of the bus can be optimized without increasing the FIFO memory, so as to save the cost.

The advantage and spirit of the invention may be understood by the following recitations together with the appended drawings.

### BRIEF DESCRIPTION OF THE APPENDED DRAWINGS

FIG. 1 is a functional block diagram illustrating the computer system according to a preferred embodiment of the invention.

FIG. 2 is a functional block diagram illustrating the arbiter shown in FIG. 1.

FIG. 3 is a schematic diagram illustrating how the arbiter shown in FIG. 2 arbitrates the mastership of the bus.

FIG. 4 is a functional block diagram illustrating the latency count unit shown in FIG. 2.

FIG. 5 is a functional block diagram illustrating the latency count unit according to another preferred embodiment of the invention.

FIG. 6 is a functional block diagram illustrating the arbiter according to another preferred embodiment of the invention.

FIG. 7 is a flowchart showing the arbitrating method according to a preferred embodiment of the invention.

### DETAILED DESCRIPTION OF THE INVENTION

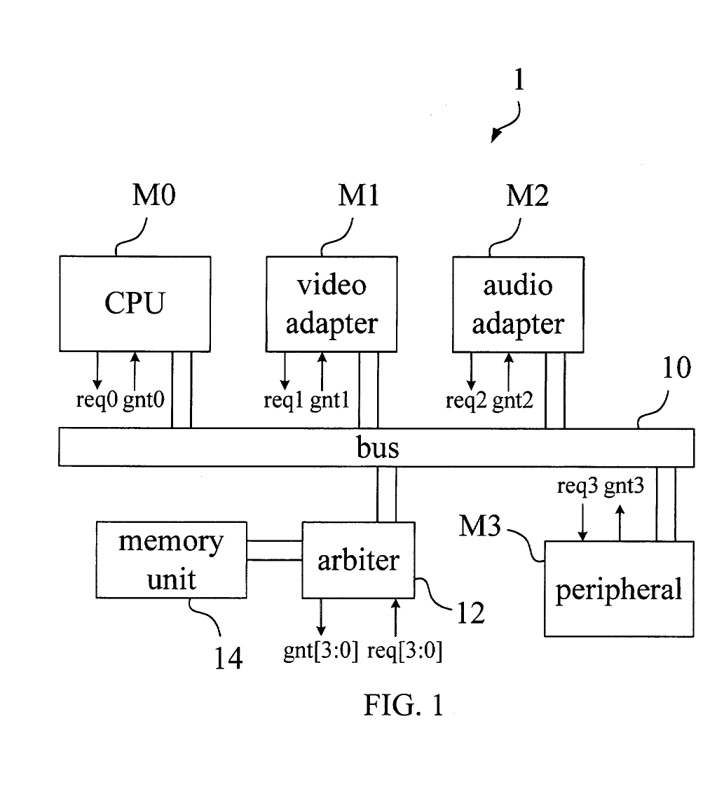

Referring to FIG. 1, FIG. 1 is a functional block diagram illustrating the computer system 1 according to a preferred embodiment of the invention. In the computer system 1, four masters M0-M3 are coupled to a bus 10, and the arbiter 12 is coupled to a memory unit 14. Each of the masters M0-M3 may be a Central Processing Unit (CPU), a video adapter, an audio adapter, or other peripheral devices. The bus 10 may be a Peripheral Component Interconnect (PCI) bus, a VESA Local (VL) bus, or the like. The memory unit 14 may be a Dynamic Random Access Memory (DRAM), a Read Only Memory (ROM), or the like. It should be noted that the number of the masters and the type of each master coupled to the bus in the computer system depend on different applications.

In this embodiment, the arbiter 12 is used for arbitrating a mastership of the bus 10. As shown in FIG. 1, the arbiter 12 utilizes a request signal req# and grant signal gnt# to communicate with each master M0-M3, so as to arbitrate the mastership of the bus 10. In other words, when a particular master desires the mastership of the bus 10, it asserts its associated request signal req# to the arbiter 12. For example, the request signal req0 is asserted by the master M0 when it requires the mastership of the bus 10, and the request signal req2 is asserted by the master M2 when it requires the mastership of the bus 10, and so on. Afterwards, corresponding grant signals gnt# are routed back to the masters from the arbiter 12 to indicate the current owner of the bus 10. Each request and grant signal pair is referred to as a bus request channel.

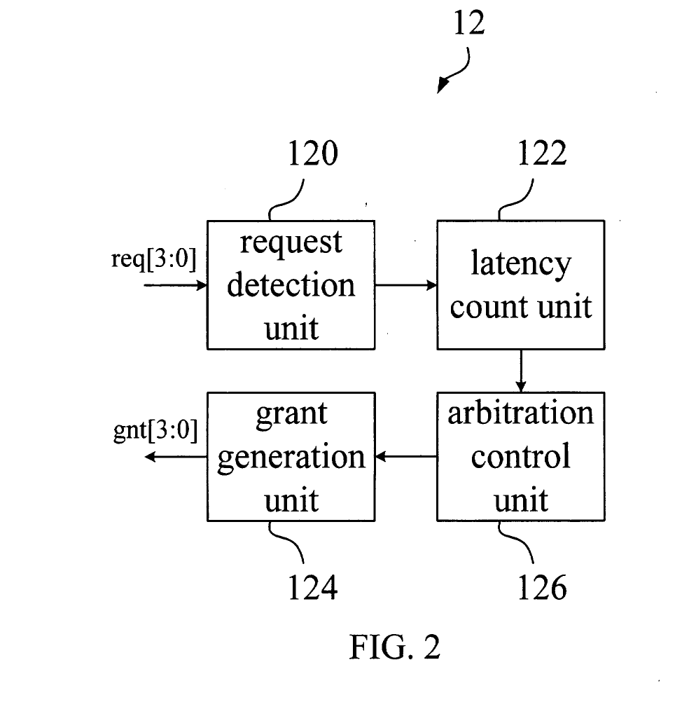

Referring to FIG. 2, FIG. 2 is a functional block diagram illustrating the arbiter 12 shown in FIG. 1. The arbiter 12 comprises a request detection unit 120, a latency count unit 122, a grant generation unit 124, and an arbitration control unit 126. As shown in FIG. 2, the latency count unit 122 is coupled to the request detection unit 120, and the arbitration control unit 126 is coupled to the latency count unit 122 and the grant generation unit 124.

The request detection unit 120 is used for detecting the request signals req0-req3 and for notifying the latency count unit 122 of the requests from the masters M0-M3. In this embodiment, each of the masters M0-M3 outputs a latency cycle while it outputs the corresponding request signal req0-req3. The latency count unit 122 is used for counting the amount of decayed latency of each request signal req0-req3 according to the latency cycle of each request signal req0-req3. The latency count unit 122 further compares the decayed latency of each request signal req0-req3, so as to determine the level of priority given to a designated master M0-M3. The latency cycle of each request signal will decay as time goes on, and the decayed latency may decay in a linear or non-linear fashion. That is to say, the latency cycle may decay either with a fixed value over a fixed span of time or a specific value over a fixed span of time according to a specific rule. The arbitration control unit 126 is configured to control the grant generation unit 124 to selectively generate a grant signal gnt0-gnt3 according to the level of priority, such that the designated master M0-M3 with a higher level of priority can possess the mastership of the bus 10 based on the grant signal gnt0-gnt3. Furthermore, when the designated master M0-M3 which owns the mastership of the bus 10 terminates its operation, the latency count unit 122 is configured to reset the level of priority given to other masters M0-M3.

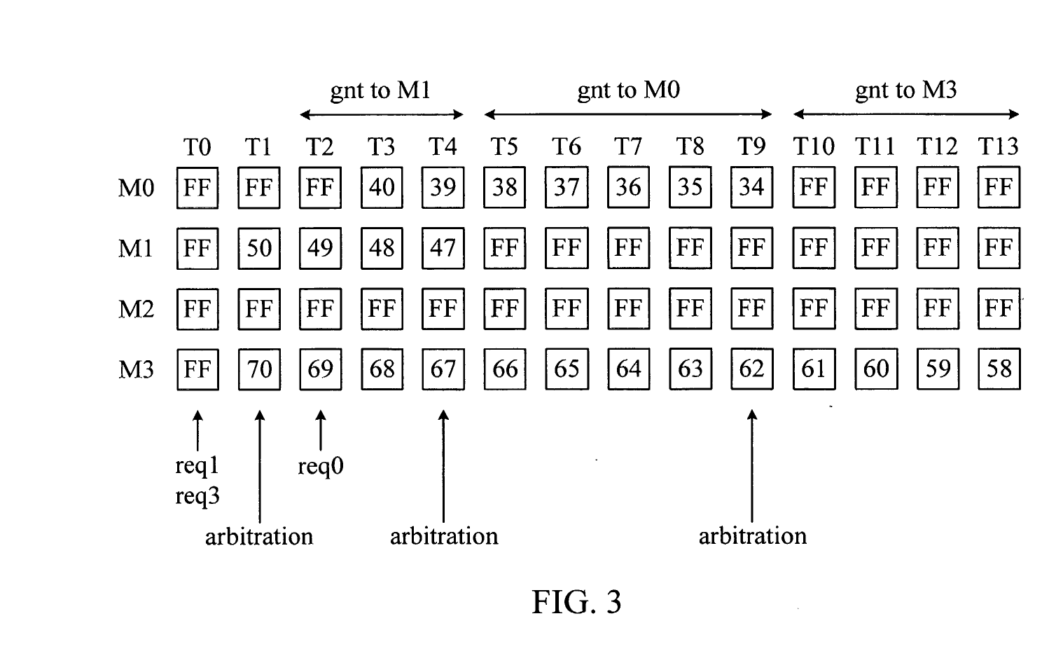

Referring to FIG. 3, FIG. 3 is a schematic diagram illustrating how the arbiter 12 shown in FIG. 2 arbitrates the mastership of the bus 10. Referring to FIG. 2 along with FIG. 3, when the request detection unit 120 detects the request signals req1 and req3 at time TO, it will notify the latency count unit 122 of the requests from the masters M1 and M3. At time T1, the latency cycle of the request signal req1 is 50, and the latency cycle of the request signal req3 is 70. The latency count unit 122 compares the decayed latency of the request signal req1 with that of the request signal req3, so as to determine the priority of the masters M1 and M3. In this embodiment, the latency cycle of the request signal req1 is smaller than that of the request signal req3, so the priority of the master M1 is higher than that of the master M3. The arbitration control unit 126 then controls the grant generation unit 124 to generate a grant signal gnt1, such that the master M1 can get the mastership of the bus 10 at time T2 based on the grant signal gnt1. At time T1, the latency count unit 122 will further count the decayed latency of each request signal req1 and req3 at all times (T1, T2, . . . ) according to the latency cycle.

When the request detection unit 120 detects the request signals req0 at time T2, it will notify the latency count unit 122 of the request from the master M0, wherein the latency cycle of the request signal req0 is 40. At the same time, the latency count unit 122 further counts the decayed latency of the request signal req0 at other times (T3, T4, . . . ) according to the latency cycle. When the master M1 which owns the mastership of the bus 10 terminates, the latency count unit 122 will reset the level of priority given to the master M0 or M3.

At time T4, the decayed latency of the request signal req0 is smaller than that of the request signal req3, so the priority of the master M0 is higher than that of the master M3. The arbitration control unit 126 then controls the grant generation unit 124 to generate a grant signal gnt0, such that the master M0 can get the mastership of the bus 10 at time T5 based on the grant signal gnt0. When the master M0 which owns the mastership of the bus 10 terminates at time T9, the latency count unit 122 will reset the level of priority given to the master M3. In other words, since there are no other masters competing with the master M3, the arbitration control unit 126 controls the grant generation unit 124 to generate a grant signal gnt3, such that the master M3 can get the mastership of the bus 10 at time T10 based on the grant signal gnt3. Accordingly, the arbiter 12 of the invention is capable of arbitrating the mastership of the bus 10 based on the latency cycle of each master and the priority of transaction, so as to optimize the bandwidth of the bus 10.

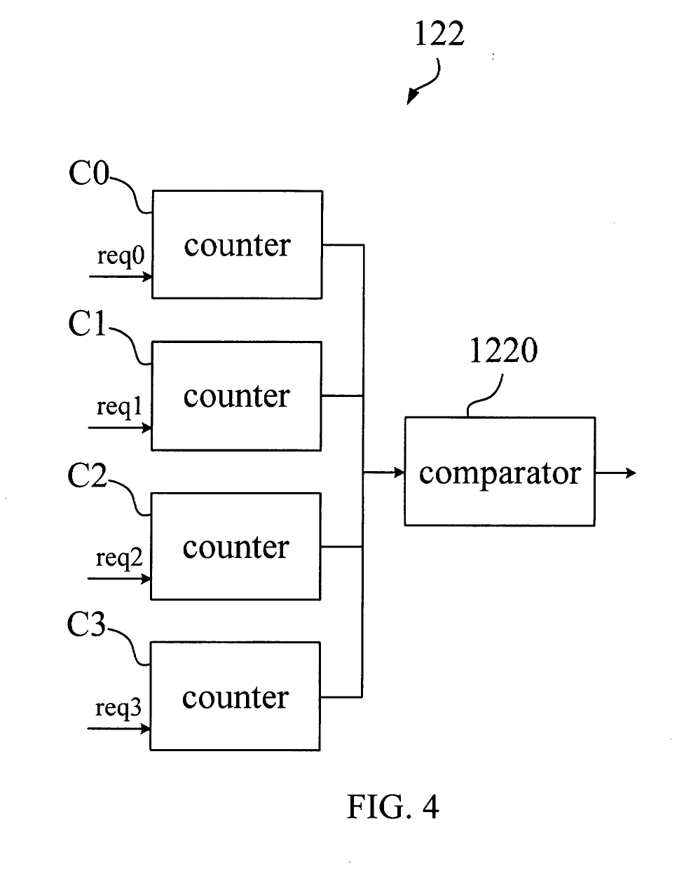

Referring to FIG. 4, FIG. 4 is a functional block diagram illustrating the latency count unit 122 shown in FIG. 2. In this embodiment, the latency count unit 122 comprises four counters C0-C3 and a comparator 1220. Each of the counters C0-C3 is used for counting the decayed latency of each request signal req0-req3 respectively. The comparator 1220 is used for comparing the decayed latency of each request signal req0-req3, so as to determine the level of priority given to the masters M0-M3.

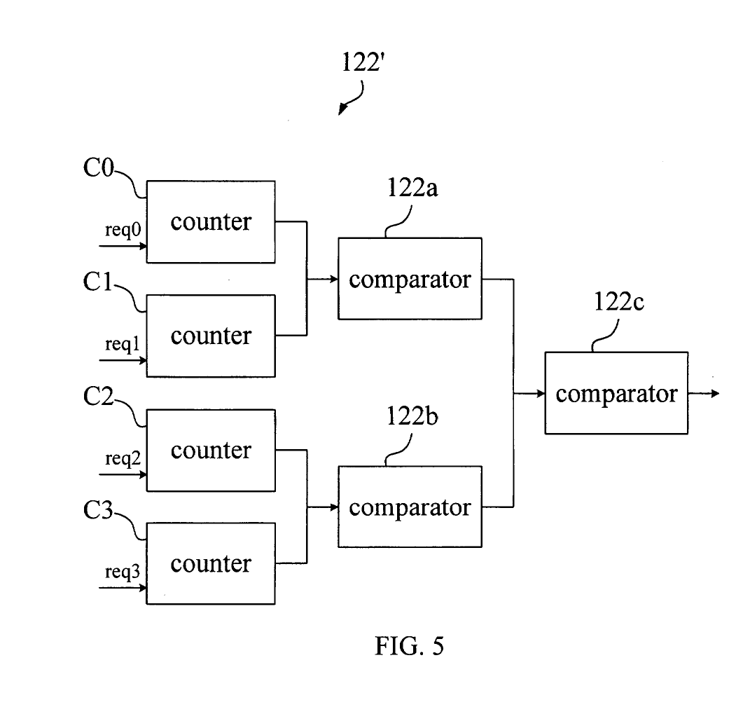

Referring to FIG. 5, FIG. 5 is a functional block diagram illustrating the latency count unit 122′ according to another preferred embodiment of the invention. In this embodiment, the latency count unit 122′ comprises four counters C0-C3 and three comparators 122a-122c. Each of the counters C0-C3 is used for counting the decayed latency of each request signal req0-req3. The comparator 122a is used for comparing the decayed latency of the request signal req0 with that of the request signal req1, so as to determine the level of priority given to the masters M0 and M1. The comparator 122b is used for comparing the decayed latency of the request signal req2 with that of the request signal req3, so as to determine the level of priority given to the masters M2 and M3. The comparator 122c is used for comparing the comparison result of the comparator 122a with that of the comparator 122b, so as to determine the final level of priority.

It should be noted that the latency count unit could be designed based on different applications.

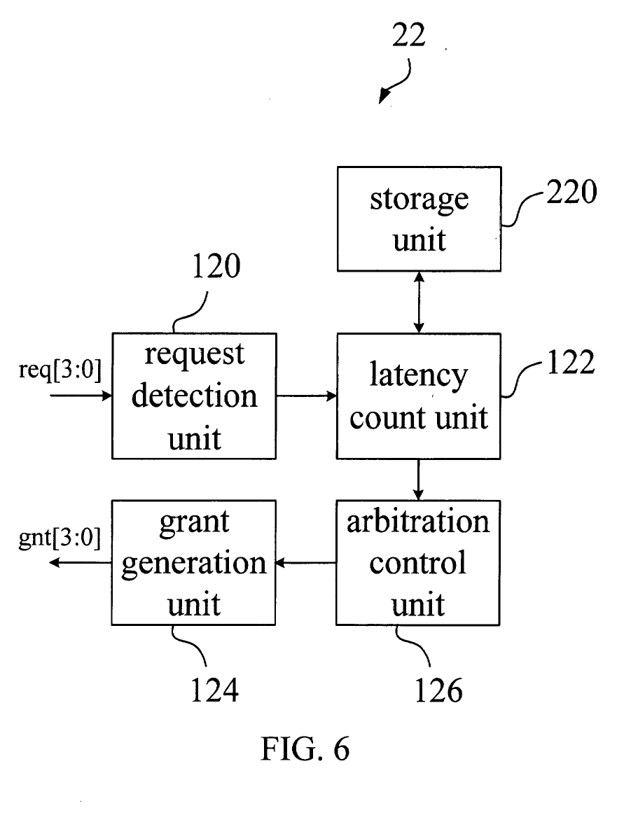

Referring to FIG. 6, FIG. 6 is a functional block diagram illustrating the arbiter 22 according to another preferred embodiment of the invention. The arbiter 22 further comprises a storage unit 220. The storage unit 220 is coupled to the latency count unit 122 and is used for storing the latency cycle of each request signal req0-req3. When the request detection unit 120 detects the request signals req0-req3 and further notifies the latency count unit 122 of the requests from the masters M0-M3, the latency count unit 122 will count the decayed latency of each request signal req0-req3 according to the latency cycle of each request signal req0-req3 stored in the storage unit 220. It is preferred that the storage unit 220 is programmable. In another embodiment, the storage unit 220 may utilize a plurality of registers to store the latency cycle of each of the request signals req0-req3. The function and principle of the arbiter 22 shown in FIG. 6 can be the same as the arbiter 12 shown in FIG. 2, and the related description will not be mentioned again here for brevity.

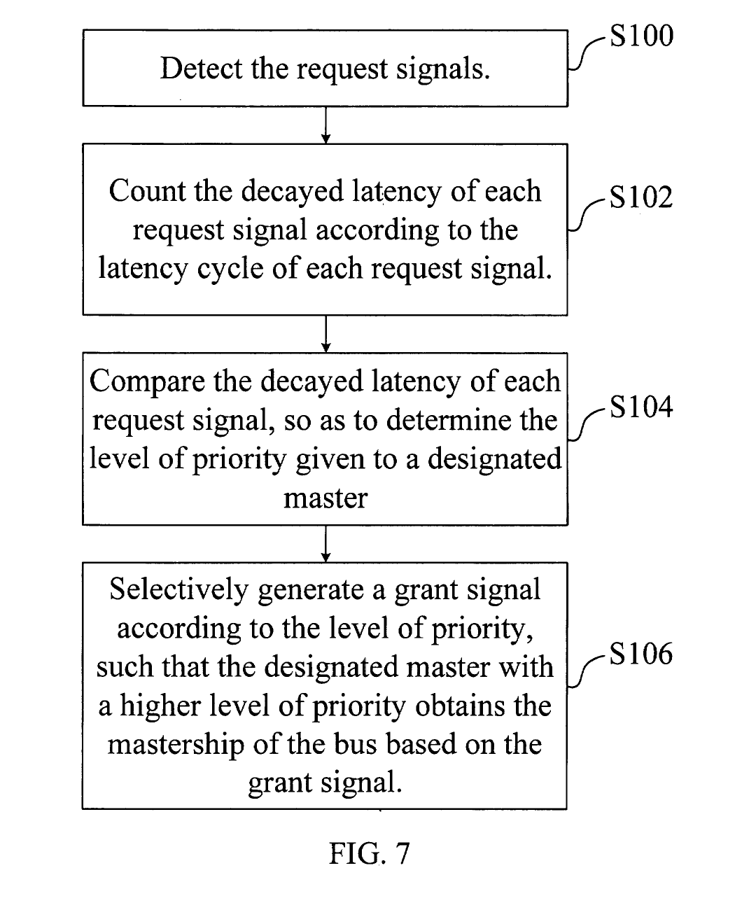

Referring to FIG. 7, FIG. 7 is a flowchart showing the arbitrating method according to a preferred embodiment of the invention. Please also refer to FIGS. 1 through 3. The arbitrating method of the invention is used for arbitrating the mastership of the bus 10, and the bus 10 is coupled to the masters M0-M3. According to the aforesaid preferred embodiment, the arbitrating method of the invention comprises the following steps. At the start, step S100 is performed to detect the request signals req0-req3. Afterwards, step S102 is performed to count the decayed latency of each request signal req0-req3 according to the latency cycle of each request signal req0-req3. Step S104 is then performed to compare the decayed latency of each request signal req0-req3, so as to determine the level of priority given to a designated master M0-M3. Step S106 is then performed to selectively generate a grant signal according to the level of priority, such that the designated master M0-M3 with a higher level of priority obtains the mastership of the bus 10 based on the grant signal.

When the designated master which owns the mastership of the bus 10 terminates, the method of the invention will reset the level of priority given to other masters M0-M3.

The arbiter of the invention is capable of arbitrating the mastership of the bus based on the latency cycle of each master and the priority of transaction. Accordingly, the bandwidth of the bus can be optimized without additional FIFO memory, thus saving manufacturing costs.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An arbiter for arbitrating a mastership of a bus, the bus being coupled to a plurality of masters, the arbiter comprising:
a request detection unit for detecting a plurality of request signals, each of which corresponding to one of the masters;
a latency count unit, coupled to the request detection unit, for counting a decayed latency of each request signal according to a latency cycle of each request signal and further comparing the decayed latency of each request signal, so as to determine a level of priority given to a designated master;
a grant generation unit; and
an arbitration control unit coupled to the latency count unit and the grant generation unit, the arbitration control unit being configured to control the grant generation unit to selectively generate a grant signal according to the level of priority, such that the designated master with a higher level of priority obtains the mastership of the bus based on the grant signal.

2. The arbiter of claim 1, wherein the latency cycle of each request signal is generated by each of the masters correspondingly.

3. The arbiter of claim 1, wherein the decayed latency decays in a linear fashion.

4. The arbiter of claim 1, wherein the decayed latency decays in a non-linear fashion.

5. The arbiter of claim 1, further comprising a storage unit, coupled to the latency count unit, for storing the latency cycle of each request signal.

6. The arbiter of claim 5, wherein the storage unit is programmable.

7. The arbiter of claim 5, wherein the storage unit comprises a plurality of registers.

8. The arbiter of claim 1, wherein the latency count unit comprises:
a plurality of counters for counting the decayed latency of each request signal; and
at least one comparator for comparing the decayed latency of each request signal, so as to determine the level of priority given to the designated master.

9. The arbiter of claim 1, wherein when the designated master which owns the mastership of the bus terminates, the latency count unit is configured to reset the level of priority given to other masters.

10. An arbitration method for arbitrating a mastership of a bus, the bus being coupled to a plurality of masters, the method comprising the steps of:
detecting a plurality of request signals, each of which corresponding to one of the masters;
counting a decayed latency of each request signal according to a latency cycle of each request signal;
comparing the decayed latency of each request signal, so as to determine a level of priority given to a designated master; and
selectively generating a grant signal according to the level of priority, such that the designated master with a higher level of priority obtains the mastership of the bus based on the grant signal.

11. The method of claim 10, wherein the decayed latency decays in a linear fashion.

12. The method of claim 10, wherein the decayed latency decays in a non-linear fashion.

13. The method of claim 10, further comprising the step of:
resetting the level of priority given to other masters when the designated master which owns the mastership of the bus terminates.

14. A computer system, comprising:
a plurality of masters, each of which being coupled to a bus;
an arbiter for arbitrating a mastership of the bus, the arbiter comprising:
a request detection unit for detecting a plurality of request signals, each of which corresponding to one of the masters;
a latency count unit, coupled to the request detection unit, for counting a decayed latency of each request signal according to a latency cycle of each request signal and further comparing the decayed latency of each request signal, so as to determine a level of priority given to a designated master;
a grant generation unit; and
an arbitration control unit coupled to the latency count unit and the grant generation unit, the arbitration control unit being configured to control the grant generation unit to selectively generate a grant signal according to the level of priority, such that the designated master with a higher level of priority obtains the mastership of the bus based on the grant signal.

15. The computer system of claim 14, wherein the latency cycle of each request signal is generated by each of the masters correspondingly.

16. The computer system of claim 14, wherein the decayed latency decays in a linear fashion.

17. The computer system of claim 14, wherein the decayed latency decays in a non-linear fashion.

18. The computer system of claim 14, wherein the arbiter further comprises a storage unit, coupled to the latency count unit, for storing the latency cycle of each request signal.

19. The computer system of claim 14, wherein the latency count unit comprises:
a plurality of counters for counting the decayed latency of each request signal; and
at least one comparator for comparing the decayed latency of each request signal, so as to determine the level of priority given to the designated master.

20. The computer system of claim 14, wherein when the designated master which owns the mastership of the bus terminates, the latency count unit is configured to reset the level of priority given to other masters.
